(19) United States
(12) Patent Application Publication
(10) Pub. No.: US 2015/0250105 A1
(43) Pub. Date: Sep. 10, 2015

(54) Scissors

(71) Applicant: Owen PAPWORTH, Portland, OR (US)

(72) Inventor: Owen Papworth, Portland, OR (US)

(21) Appl. No.: 14/435,405

(22) PCT Filed: Dec. 18, 2013
(86) PCT No.: PCT/US13/76280

§ 371 Date: Apr. 13, 2015

Related U.S. Application Data
(60) Provisional application No. 61/740,843, filed on Dec. 21, 2012.

(51) Int. Cl. A01G 3/02; B26B 13/28; B26B 13/06

(52) U.S. Cl. CPC A01G 3/02; B26B 13/06; B26B 13/28

(57) ABSTRACT

The improved pair of scissors or shears includes cooperating blades that operate conventionally. Each respective blade includes an acutely recessing trailing edge having about a 16-degree taper from a reference line perpendicular to the cutting plane and a cutting surface having a ratio substantially about 1:2 to about 1:5 relative to the blade thickness.

### PRIORITY CLAIM

The present invention, being filed as a Patent Cooperation Treaty application, claims benefit for all purposes, including benefit under 35 USC Section 119(e), of U.S. Provisional Patent Application No. ______ filed on 21 Dec. 2012 entitled “Improved Scissors” by the common inventor Owen Papworth.

### BACKGROUND

The present invention relates to scissors or shears and more specifically to agricultural scissors having canted blades.

In horticulture, viticulture, and other related agricultural activities, pruning plants is necessary to promote advantageous characteristics of the plant. For example, fruit trees are pruned to promote annual fruit-production of tasty, storable, transportable, and healthy fruit, to control growth, remove dead or diseased wood, and stimulate the formation of flowers and fruit buds. Pruning often means cutting branches back, sometimes removing smaller limbs entirely. It may also mean the removal of young shoots, buds, and leaves.

A particularly common approach to pruning small branches, new growth, and young shoots involves clipping with a small scissors or shears. However, due to sap and other debris that results during this process, the scissor or shear blades become dirty, sticky, and after about 10-minutes of rapid pruning, the blades are not suitable for cutting, and require a cleaning to remove this detritus from the blades. This results in lost productivity.

Therefore, there is a need for a scissors or shears that reduce or eliminate the build-up of detritus on the blade during a pruning operation.

### DRAWING

FIG. 1 is side view of a pair of scissors of the prior art.

FIG. 2 is a side view of a pair of scissors having an improved blade according to one preferred embodiment of the present invention.

FIG. 3 is a side view of another pair of scissors having improved blades according to a second preferred embodiment of the present invention.

FIG. 4 is a cross-sectional view of a pair of blades from the pair of scissors of FIG. 3 along the line 4-4.

FIG. 5 is a front view with the blades apart of the pair of scissors of FIG. 3.

FIG. 6 is a top view of the pair of scissors of FIG. 3.

FIG. 7 is a mid-section cross-section from the front end of a pair of blades from a pair of scissors of the prior art.

FIG. 8 is an offset frontal view of another preferred embodiment of the present invention.

FIG. 9 is a detail view of the cutting blade portion of the embodiment of FIG. 8.

FIG. 10 is another detail view of the cutting blade portion of the embodiment of FIG. 8.

FIG. 11 is yet another preferred embodiment of the present invention.

FIG. 12 is cross-sectional view of one blade of a pair of scissors or shears according to any of the preferred embodiments of the present invention.

### DESCRIPTION OF THE INVENTION

Possible embodiments will now be described with reference to the drawings and those skilled in the art will understand that alternative configurations and combinations of components may be substituted without subtracting from the invention. Also, in some figures certain components are omitted to more clearly illustrate the invention.

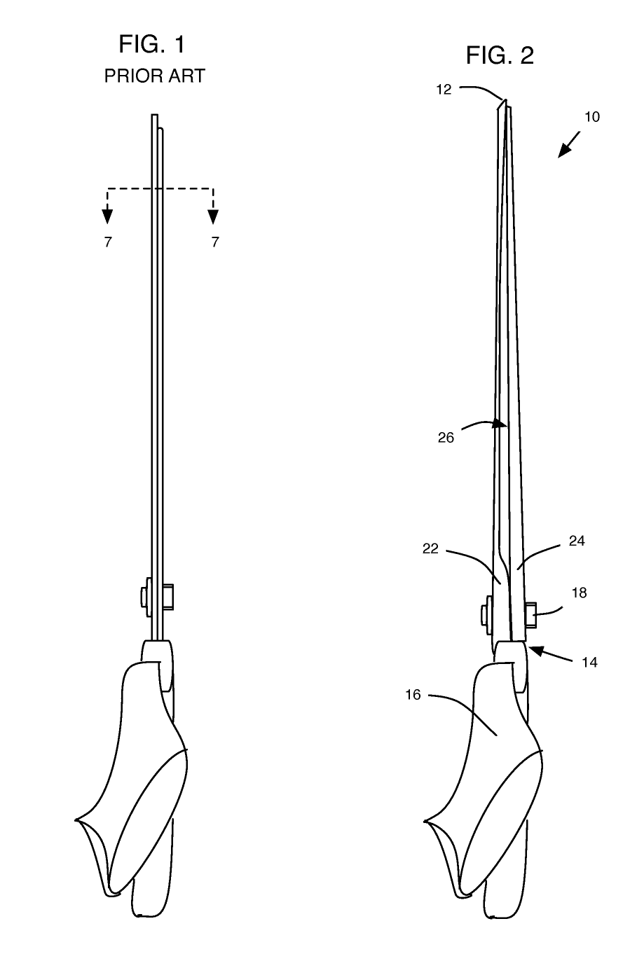

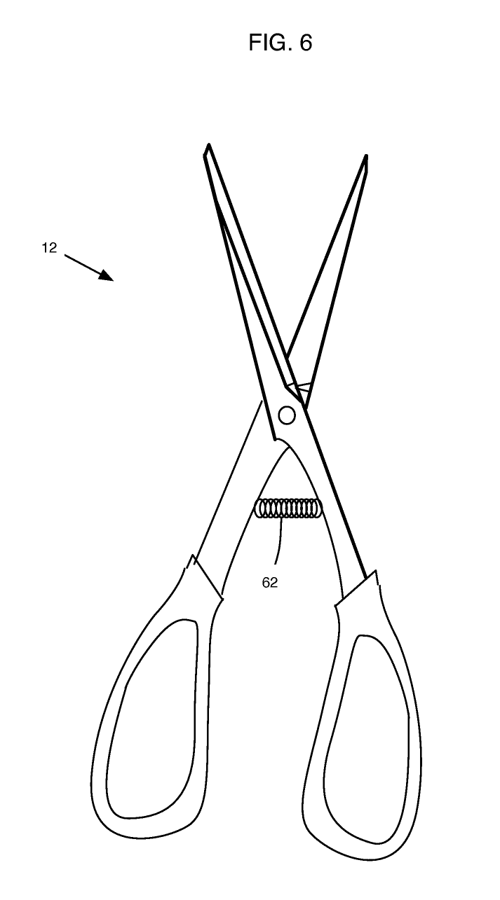

The present invention contemplates a pair of pruning shears or scissors that has a pair of cooperating blades. The pair of cooperating blades differs from the prevalent teaching in the art. A prior art pair of scissors, see FIG. 1 for example, has two cooperating blades wherein each blade presents a nearly vertical and relatively wide cutting surface. This is best appreciated by looking at FIG. 7, which is a representational cross-section of a pair of blades looking at the cross section from the end of the scissors of FIG. 1 along the line 7-7. The cut occurs at the cooperating cutting edge E, when a piece of material is sheared by the relative movement of each blade B1 and B2 moving toward each other. To increase precision and effectiveness, the blade of the prior art also includes considerable mass, which further serves to stiffen each blade to reduce deflection. A close tolerance between the two blades allows the blades to slide past each other. Too large of a gap and the material cannot be cut, to small of a gap and the blades will contact, bind, and not be operable to cut the material.

This large flat area of the cutting edge E is very effective at cutting or sheering thin material. However, as the size of the object being cut increases, this flat edge E becomes a hindrance. To counter this, the prior art teaches curved blades. The curved blades also present a flat cutting edge, however the cut zone changes as the two curved blades move toward each other, this has the affect of reducing the friction on the flat edge.

However, in each of these aforementioned prior art teaching, a flat, relatively wide, blade cutting edge is used, and this blade cutting edge becomes covered in sap or other detritus from the material being cut, which necessitates a periodic cleaning. In large-scale nursery environments, or in commercial fruit farming, for example, this periodic cleaning results in a significant loss in productivity.

The present invention contemplates cooperating blades that have a compound taper on each blade. This compound taper produces a visible gap 26 between the blades, see FIG. 2, for example, and this compound taper will be further described below.

Also referring to FIG. 2, the present invention contemplates scissors 10 or pruning shears having cooperating blades 22 and 24 pivotably coupled together conventionally by a fastener 18. A tip 12 terminates the distal end of the blades and a handle 16 conventionally couples to the proximal end 14 of the blades.

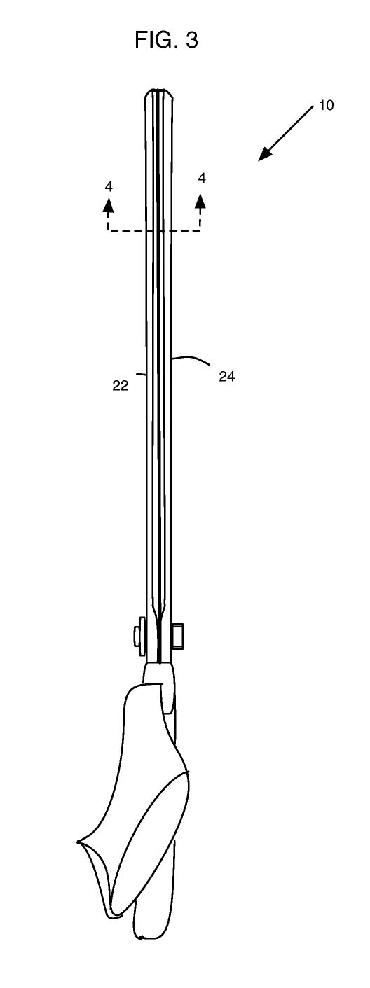

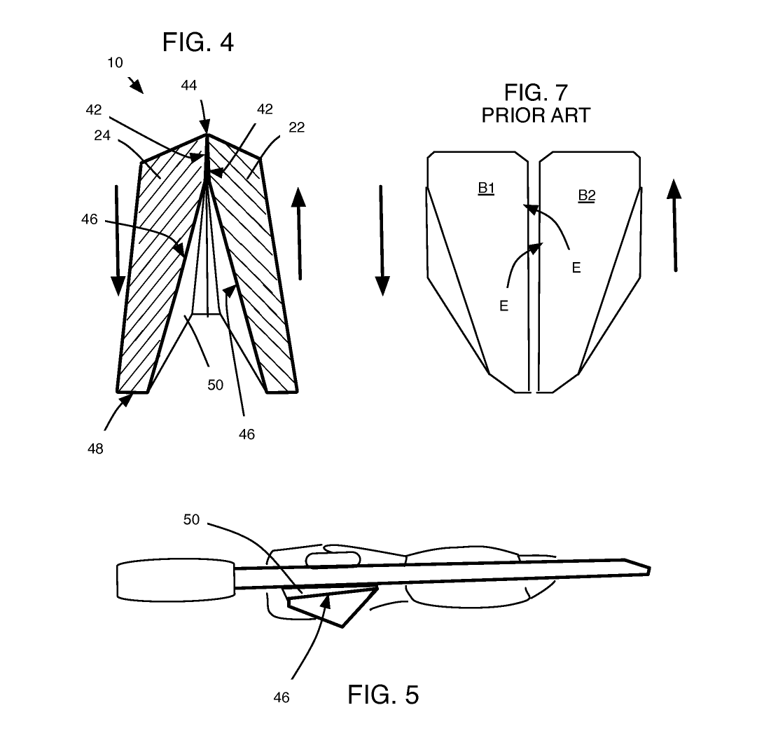

FIGS. 3-5 better illustrate the compound taper of each pair of blades for a scissors 10 or pruning shears according to preferred embodiments of the present invention. FIG. 3 shows a side view of a pair of scissor according to the present invention. A reference line 4-4 illustrates a cross section illustrated in FIG. 4.

Specifically referencing FIG. 4, a pair of cooperating blades 24 and 22 each includes a compound taper. Each blade has a very small shearing surface (cutting face) 42, which operates similar to a conventional cutting edge (see reference edge E in FIG. 7, for example—but with important geometric differences, as described below) arranged near the top 44 of the blade.

However, the cutting face 42 gives way immediately to a first vertical taper feature 46 that terminates at a bottom 48 of each blade. (The two cooperating blades 24 and 22 are mirror images and symmetric with respect to the other). A second taper runs parallel to an imaginary axis that extends perpendicular to the page in the drawing of FIG. 4, this second tapered edge 50 is broader at the distal end 20 of the blade and narrows as it approaches the proximal end.

The first taper, along the shorter axis creates about a 1-45 degree taper, but preferably about 5-degrees to about 16-degrees of taper from vertical as measured from a 90-degree vertical line (0-degrees). The second taper, running along a long axis of the blade, creates about from about 1-30 degrees of taper, but preferably 15 degrees.

FIG. 6, a second contemplated preferred embodiment, illustrates a pruning shear 12 having the compound taper just described in relation to the scissors 10 of FIGS. 3-5. The pruning shears 12 includes a return biasing member 62, such as a helically wound coil spring. The use and operation of this spring biasing member 62 is well understood by those having ordinary skill in this art.

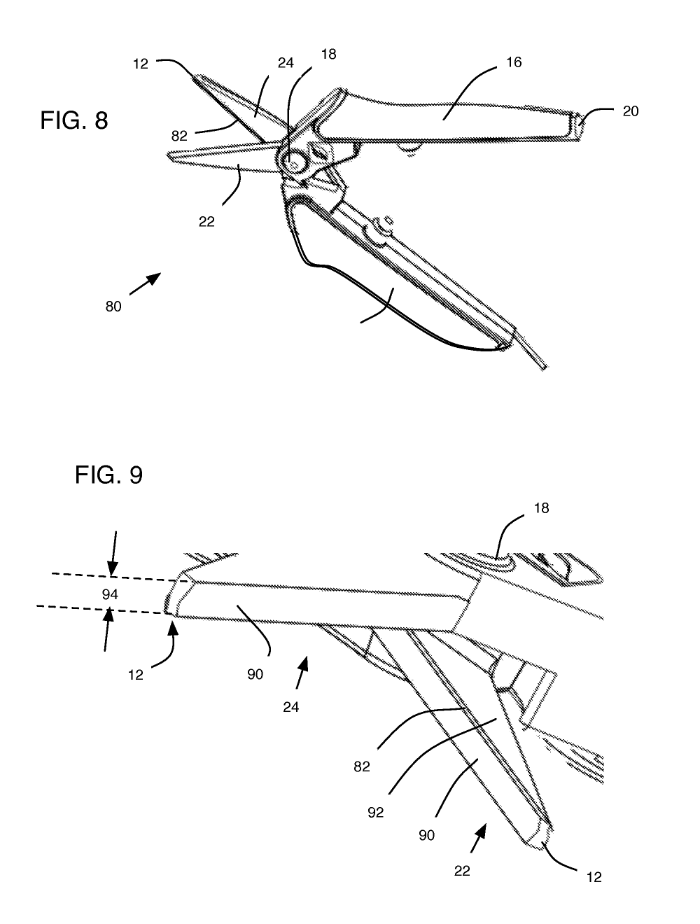

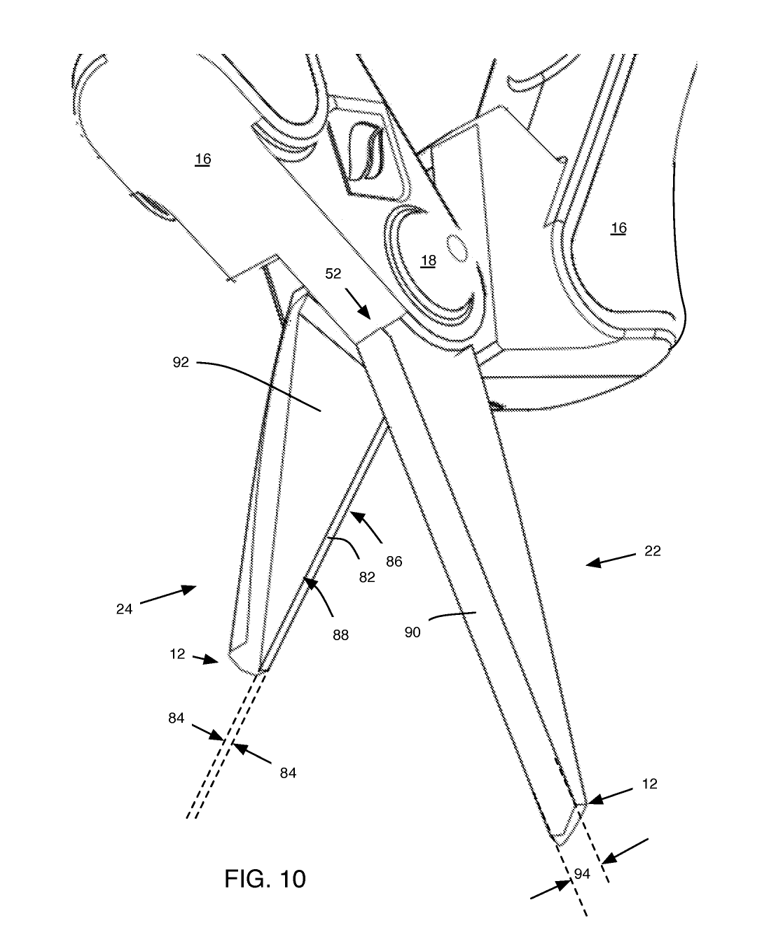

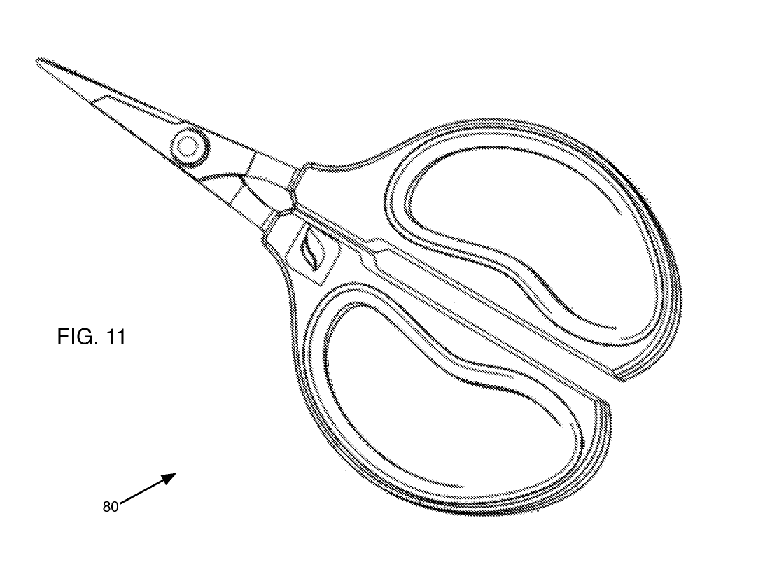

In yet another preferred embodiment, the present invention provides a scissors or shears 80 that combines the self-cleaning, narrow cut, and precise cut features of a thin wire with the robustness, toughness, and durability of a conventional scissors or shears. To achieve this, the cooperating cutting faces 82 of the first and second blade (22 and 24, respectively) are flat faces that are very narrow in width 84. FIGS. 8-12 illustrate another contemplated embodiment of a pair of cooperating blades with these features.

FIG. 8 illustrates a pair of scissors 80 and FIG. 11 illustrates a pair of shears 80. Making particular reference to the embodiment illustrated in FIGS. 8-12, for example, this improved pair of scissors or pruning shears (common reference number 80) utilize well-understood cutting mechanics and improve thereupon. As would be appreciated by those with skill in the art, the scissors 80 or shears 80 have a pair of blades consisting of a first blade 22 cooperating with a second blade 24 and being pivotably mounted with respect to each other. Each blade respectively further has a tip 12 at a distal end 20 and a handle portion 16 at a proximal end 14. The improvement comprises a modified first blade 22 having a cutting face 82 extending from a distal end 20 to a proximal position 52. The cutting face 82 has an overall width 84 defined between a cutting edge 86 and an offset and parallel trailing edge 88. This relatively narrow cutting face can be expressed in terms of a ratio relative to the thickness of the cutting blade (22 or 24) as measured as the width 94 of the leading face 90, for example. This ratio of cutting face to leading face is substantially between about 1:2 to about 1:5 ratio.

Also, the surface of the cutting face defines a plane referred to as the cutting plane.

The leading face 90 arranged somewhat perpendicular, although this is not necessarily a 90-degree angle and can vary from about 75-degrees to about 120-degrees, for example. A common edge between the leading face 90 and the cutting face 82 is the cutting edge 86. A common edge between the cutting face 82 and the trailing face 92 is the trailing edge 88. The cutting face is therefore the surface defined between the cutting edge 86 and the substantially parallel trailing edge 88 from the tip 12 to an intermediate position 52.

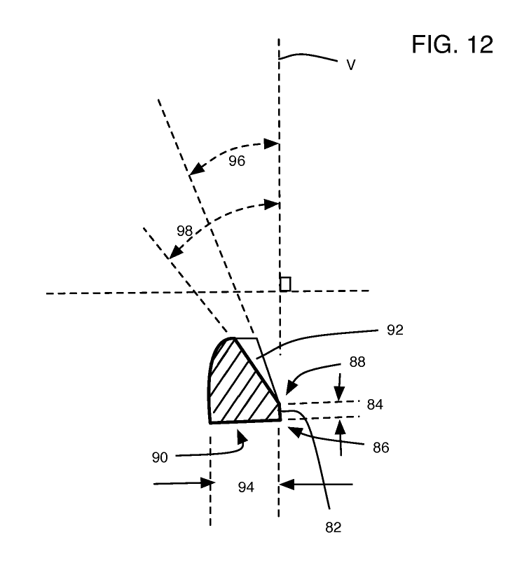

The trailing face 92 extends from the trailing edge and extending at a tip angle substantially from 70-degrees to 90-degrees relative to the cutting plane. Or expressed differently, from a vertical reference line V (see, for example, FIG. 12), this first tip angle 98 is about 16 degrees, but preferably between 3 degrees and 45-degrees. A second tip angle 96 from substantially between 3 and 45-degrees may be used as a manufacturing convenience as the proximal end of a blade tends to be thicker than its proximal end, thus making an taper extending from the tip to the handle.

The cutting face 82 is preferably about 0.6-mm to about 0.7-mm but a range of less than 0.1 mm (approximating a thin, strong wire) to approximately 1.0-mm would work and may only be limited by the type of manufacturing process used (i.e, grinding, or milling, or molding powder metal). The overall blade thickness 90 is preferably about 2.0-mm to about 3.0-mm. Thus, the preferred ratio of cutting surface to blade thickness is from about 1:2.875 to about 1:5 and more preferably about 1:1.333 to 1:1.4.

The taper on the trailing surface is ideally 0-degrees (impossible) to as small as possible (from vertical—want it to be like a wire) up to a 20-degree, with a preferred range between 3-degrees to 16-degrees.

In one contemplated embodiment, the scissors or shears are made from powdered metal with a lubricant pre-impregnated during the formation of the blades.

Although the invention has been particularly shown and described with reference to certain embodiments, it will be understood by those skilled in the art that various changes in form and detail may be made without departing from the spirit and scope of the invention.

I claim:

1. An improved pair of scissors or pruning shears wherein the scissors or shears comprises a first blade cooperating with a second blade and the first and second blades being pivotably coupled to each other, and each blade respectively further comprising a tip at a distal end and a handle portion at a proximal end, the improvement comprising:
the first blade further comprising
a first-blade cutting face extending from a distal end to a proximal position, the cutting face having an overall width defined between a cutting edge and an offset and parallel trailing edge wherein the width is substantially between a 1:2 to 1:5 ratio of the cutting surface relative to a thickness of a leading face, and further the cutting face defines a cutting plane,
the leading face arranged substantially perpendicular to the cutting face and extending from the cutting edge,
a trailing face extending from the trailing edge and extending at a tip angle substantially from 3-degrees to 45-degrees relative to a vertical reference line perpendicular to the cutting plane.

2. The improved pair of scissors or pruning shears of claim 1 further comprising:
the second blade further comprising
a second-blade cutting face extending from a distal end to a proximal position, the cutting face having an overall width defined between a cutting edge and an offset and parallel trailing edge wherein the width is substantially between a 1:2 to 1:5 ratio of the cutting surface relative to a thickness of a leading face, and further the cutting face defines a cutting plane,
the leading face arranged substantially perpendicular to the cutting face and extending from the cutting edge,
a trailing face extending from the trailing edge and extending at a tip angle substantially from 3-degrees to 45-degrees relative to a vertical reference line perpendicular to the cutting plane.

3. The improved pair of scissors or pruning shears of claim 1 further comprising:
a return biasing member coupled to each blade.

4. The improved pair of scissors or pruning shears of claim 1 wherein:
the ratio of the width of the cutting surface to the thickness of the blade as determined by the thickness of the leading face is substantially from 1:3.30 to 1:3.40.

5. The improved pair of scissors or pruning shears of claim 1 wherein:
the ratio of the width of the cutting surface to the thickness of the blade as determined by the thickness of the leading face is substantially from 1:2.50 to 1:2.90.

6. The improved pair of scissors or pruning shears of claim 1 wherein:
the ratio of the width of the cutting surface to the thickness of the blade as determined by the thickness of the leading face is substantially from 1:4.90 to 1:5.10.

7. The improved pair of scissors or pruning shears of claim 1 wherein:
the trailing face tip angle is substantially from 7-degrees to 20-degrees.
